(19) United States
(12) Patent Application Publication
(10) Pub. No.: US 2022/0097002 A1
(43) Pub. Date: Mar. 31, 2022

(54) EXHAUST PURIFICATION DEVICE AND VEHICLE

(71) Applicant: ISUZU MOTORS LIMITED, Tokyo (JP)

(72) Inventors: Kento KANEDA, Fujisawa-shi, Kanagawa (JP); Yuuta KAGEYAMA, Fujisawa-shi, Kanagawa JP (JP)

(21) Appl. No.: 17/298,049

(22) PCT Filed: Nov. 25, 2019
(86) PCT No.: PCT/JP2019/045925

§ 371 Date: May 28, 2021

(30) Foreign Application Priority Data
Nov. 29, 2018 (JP) 2018-223383

(51) Int. Cl. B01D 53/94; F01N 3/20; F01N 3/28

(52) U.S. Cl. CPC B01D 53/9481; B01D 53/9409; F01N 3/2066; F01N 2610/02; B01D 2251/2067; B01D 2258/012; F01N 2240/20; F01N 3/2892

(57) ABSTRACT

This exhaust purification device is provided with: an exhaust pipe through which exhaust gas generated in an internal combustion engine flows; a selective reduction catalyst which is provided in the exhaust pipe and which promotes reduction of nitrogen oxide in the exhaust gas; a reducing agent supply unit which is provided in a stage before the selective reduction catalyst in the exhaust pipe and which supplies a reducing agent for reducing nitrogen oxide in the exhaust gas; and a blocking unit which is disposed between the reducing agent supply unit and the selective reduction catalyst in the exhaust pipe and which, when a reducing agent solid flows through the exhaust pipe together with the exhaust gas, cuts off movement of the reducing agent solid towards the selective reduction catalyst.

### TECHNICAL FIELD

The present disclosure relates to an exhaust purification apparatus and a vehicle.

### BACKGROUND ART

In the related art, for an exhaust purification apparatus for an internal combustion engine, a configuration is known in which ammonia is generated by a reducing agent such as urea water and reduction action of the ammonia and nitrogen oxide in an exhaust gas is promoted using a selective reduction catalyst (for example, see Patent Literature (hereinafter, referred to as “PTL”) 1). The reducing agent is supplied to an exhaust pipe by an injection apparatus or the like provided in a stage before the selective reduction catalyst in the exhaust pipe.

### CITATION LIST

### Patent Literature

PTL 1
Japanese Patent Application Laid-Open No. 2017-36672

### SUMMARY OF INVENTION

### Technical Problem

However, when an exhaust gas is in a state of relatively low temperature during e.g. low-load operation of an internal combustion engine or the amount of a supplied reducing agent becomes excessively large, the reducing agent may not evaporate in an exhaust pipe and may solidify into a solid (hereinafter, referred to as “reducing agent solid”).

When this reducing agent solid reaches a selective reduction catalyst together with an exhaust gas, the reducing agent solid comes into contact with the selective reduction catalyst. When the reducing agent solid comes into contact with the selective reduction catalyst, a catalyst on a catalyst support forming the selective reduction catalyst may be scraped off by the reducing agent solid, and further purification efficiency of an exhaust gas in an exhaust purification apparatus may decrease.

An object of the present disclosure is to provide an exhaust purification apparatus and a vehicle that are capable of restraining a catalyst of a selective reduction catalyst from being scraped off by a reducing agent solid, and further restraining a decrease in purification efficiency of an exhaust gas.

### Solution to Problem

An exhaust purification apparatus according to the present disclosure includes: an exhaust pipe through which an exhaust gas generated in an internal combustion engine flows; a selective reduction catalyst provided in the exhaust pipe and promoting reduction of nitrogen oxide in the exhaust gas; a reducing agent supply part provided in a stage before the selective reduction catalyst in the exhaust pipe and supplying a reducing agent that reduces the nitrogen oxide in the exhaust gas; and a blocking part which is provided between the reducing agent supply part and the selective reduction catalyst in the exhaust pipe, and which, when the reducing agent solid flows through the exhaust pipe together with the exhaust gas, blocks movement of a reducing agent solid towards the selective reduction catalyst.

A vehicle according to the present disclosure includes the exhaust purification apparatus described above.

### Advantageous Effects of Invention

According to the present disclosure, it is possible to restrain a catalyst of a selective reduction catalyst from being scraped off by a reducing agent solid, and further to restrain a decrease in purification efficiency of an exhaust gas.

### BRIEF DESCRIPTION OF DRAWINGS

FIG. 1 is a schematic configuration diagram illustrating an exhaust system of an internal combustion engine to which an exhaust purification apparatus according to an embodiment of the present disclosure is applied;

FIG. 2A is a diagram for describing how a reducing agent solid scrapes off a catalyst from a substrate;

FIG. 2B is a diagram for describing how the reducing agent solid scrapes off the catalyst from the substrate;

FIG. 3 is a diagram for describing how a blocking part blocks movement of the reducing agent solid; and

FIG. 4 is a schematic configuration diagram illustrating an exhaust system of an internal combustion engine to which an exhaust purification apparatus according to a variation is applied.

### DESCRIPTION OF EMBODIMENTS

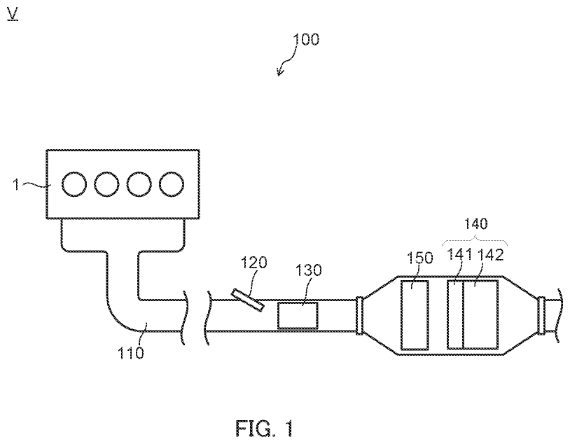

Hereinafter, an embodiment of the present disclosure will be described in detail with reference to the accompanying drawings. FIG. 1 is a schematic configuration diagram illustrating an exhaust system of internal combustion engine 1 to which exhaust purification apparatus 100 according to the embodiment of the present disclosure is applied.

As illustrated in FIG. 1, internal combustion engine 1 is, for example, a diesel engine mounted on vehicle V. Internal combustion engine 1 is provided with exhaust purification apparatus 100 for guiding an exhaust gas generated in internal combustion engine 1 into the atmosphere. Exhaust purification apparatus 100 includes exhaust pipe 110, reducing agent supply part 120, mixing part 130, selective reduction catalyst 140, and blocking part 150.

An exhaust gas generated from internal combustion engine 1 flows through exhaust pipe 110. Exhaust pipe 110 is provided with reducing agent supply part 120, mixing part 130, blocking part 150, selective reduction catalyst 140, and the like in this order from an upstream side of a direction in which an exhaust gas flows (a direction from the left to the right in the drawing; hereinafter, referred to as “emission direction”).

Reducing agent supply part 120 supplies a reducing agent (urea water) for generating ammonia to exhaust pipe 110. When the reducing agent is supplied to exhaust pipe 110 by reducing agent supply part 120, the reducing agent is hydrolyzed due to the temperature in exhaust pipe 110 to generate ammonia.

Mixing part 130 is provided in a stage after reducing agent supply part 120 in exhaust pipe 110, and mixes the reducing agent and an exhaust gas.

Selective reduction catalyst 140 is provided in a stage after reducing agent supply part 120 and mixing part 130 in exhaust pipe 110, and includes catalyst 141 and substrate 142.

Substrate 142 supports catalyst 141 on an end surface on an upstream side in the emission direction, and has a structure, such as a honeycomb structure, in which a passage hole through which an exhaust gas can pass is formed.

Selective reduction catalyst 140 adsorbs ammonia generated based on the reducing agent supplied by reducing agent supply part 120. Selective reduction catalyst 140 reacts the adsorbed ammonia with nitrogen oxide contained in an exhaust gas passing through selective reduction catalyst 140 to reduce the nitrogen oxide.

Blocking part 150 is disposed separated from selective reduction catalyst 140, between reducing agent supply part 120 and selective reduction catalyst 140 in exhaust pipe 110. Blocking part 150 has a structure identical to the structure of substrate 142, and is configured such that an exhaust gas can pass through blocking part 150 in the same manner as substrate 142. Further, blocking part 150 blocks movement of a reducing agent solid towards selective reduction catalyst 140 when the reducing agent solid flows through exhaust pipe 110 together with an exhaust gas.

When an exhaust gas is in a state of relatively low temperature or the amount of the reducing agent supplied by reducing agent supply part 120 becomes excessively large, the reducing agent may not evaporate in the exhaust pipe and may solidify into a reducing agent solid.

An exhaust gas is in a state of relatively low temperature when internal combustion engine 1 operates at a low load. Further, the amount of the reducing agent supplied by reducing agent supply part 120 becomes excessively large when a control system that controls the supply amount of the reducing agent has a certain trouble such as a failure of a sensor.

As reasons why the reducing agent does not evaporate and becomes a reducing agent solid, it is possible to mention a case where the reducing agent does not vaporize and solidifies due to an exhaust gas being in a low-temperature state, a case where the reducing agent solidifies due to insufficient mixing by mixing part 130, and the like.

As reasons why mixing by mixing part 130 is insufficient, it is possible to mention a case where the reducing agent and an exhaust gas are not appropriately mixed due to performance of mixing part 130, a case where the reducing agent from reducing agent supply part 120 is not properly supplied to the position of mixing part 130, and the like.

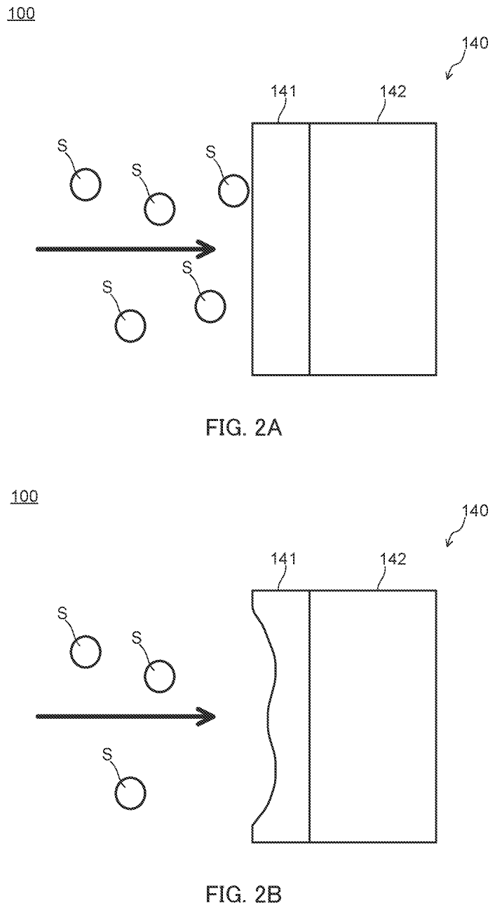

A reducing agent solid generated in this manner moves onto a downstream side in the emission direction by the flow of an exhaust gas. Here, as illustrated in FIG. 2A, in a case where it is configured that exhaust purification apparatus 100 does not include blocking part 150, reducing agent solid S comes into contact with catalyst 141 supported on the end surface of substrate 142 when reducing agent solid S reaches selective reduction catalyst 140.

Then, as illustrated in FIG. 2B, catalyst 141 is scraped off by reducing agent solid S and the amount of catalyst 141 in selective reduction catalyst 140 decreases so that purification efficiency of an exhaust gas in exhaust purification apparatus 100 decreases. Further, substrate 142 and catalyst 141 are scraped by reducing agent solid S depending on the material of substrate 142 so that selective reduction catalyst 140 may be damaged.

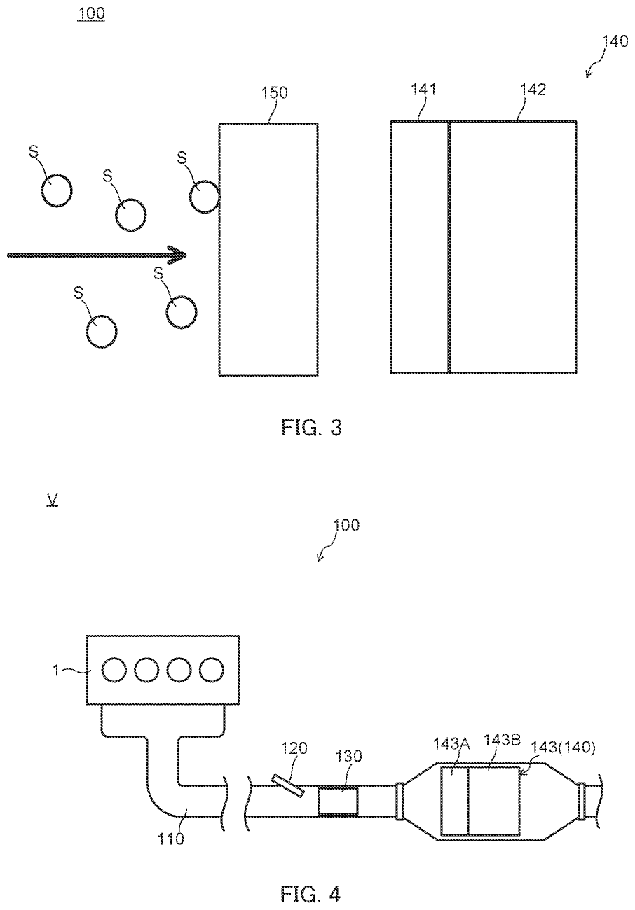

In the present embodiment, on the other hand, blocking part 150 blocks movement of reducing agent solid S towards selective reduction catalyst 140 as illustrated in FIG. 3. Thus, reducing agent solid S no longer moves towards selective reduction catalyst 140 so that it is possible to restrain catalyst 141 of selective reduction catalyst 140 from being scraped off by reducing agent solid S. As a result, it is possible to restrain a decrease in purification efficiency of an exhaust gas in exhaust purification apparatus 100. Further, in the same manner, it is possible to restrain selective reduction catalyst 140 from being damaged by reducing agent solid S.

Further, when blocking part 150 is configured to be in contact with selective reduction catalyst 140, blocking part 150 may become exhaust gas flow resistance and a pressure loss may occur. More specifically, since blocking part 150 and substrate 142 have an identical structure, the presence of blocking part 150 may become exhaust gas flow resistance and further a pressure loss may occur when passage holes for an exhaust gas in blocking part 150 and substrate 142 are not aligned with each other. Further, selective reduction catalyst 140 may be damaged depending on the material of substrate 142 or by peeling of catalyst 141 of selective reduction catalyst 140 by blocking part 150 when selective reduction catalyst 140 and blocking part 150 are inserted into exhaust pipe 110 at the time of manufacturing exhaust purification apparatus 100.

In the present embodiment, on the other hand, blocking part 150 is separated from selective reduction catalyst 140 so that it is possible to restrain occurrence of problems as described above. Further, since it is not necessary to align passage holes of blocking part 150 and substrate 142 with each other, it is possible to simplify a process of assembling exhaust purification apparatus 100. Further, from the viewpoint of restraining occurrence of the problems described above, blocking part 150 is preferably separated from selective reduction catalyst 140 as much as possible. Further, blocking part 150 may be disposed so as to be in contact with selective reduction catalyst 140 as long as the problems described above can be solved.

Further, blocking part 150 is preferably formed of a material harder than reducing agent solid S. For example, blocking part 150 is preferably made of a metal.

When blocking part 150 is formed of a material softer than reducing agent solid S, blocking part 150 is scraped when reducing agent solid S comes into contact with blocking part 150. For this reason, blocking part 150 may gradually become thinner, and further blocking part 150 may be in a state of being completely pulverized.

When blocking part 150 is formed of a material harder than reducing agent solid S, on the other hand, blocking part 150 is no longer pulverized by reducing agent solid S even when reducing agent solid S comes into contact with blocking part 150. As a result, it is possible to continue maintaining the effect of blocking part 150.

Further, since blocking part 150 is not pulverized by reducing agent solid S, blocking part 150 can be configured to be relatively thinner so that it is possible to contribute to a decreased size of the apparatus in its entirety.

Further, in a case where blocking part 150 is made of a material softer than reducing agent solid S, blocking part 150 is preferably as thick as possible from the viewpoint of blocking part 150 becoming hardly completely pulverized.

Further, blocking part 150 and substrate 142 may be formed of the same material or may be formed of different materials.

Note that, in the embodiment described above, blocking part 150 is disposed separated from selective reduction catalyst 140, but the present disclosure is not limited thereto. For example, as illustrated in FIG. 4, the blocking part may also be formed integrally with substrate 143 of selective reduction catalyst 140.

Substrate 143 in this configuration includes upstream region 143A on an upstream side in the emission direction, and downstream region 143B on a downstream side in the emission direction. Upstream region 143A forms the blocking part and is a non-support region on which a catalyst is not supported, and downstream region 143B is a support region on which a catalyst is supported. That is, the blocking part is located more on an upstream side in the emission direction than the support region.

Even in this way, it is possible to restrain a reducing agent solid from reaching the support region, which is a region where a catalyst is supported, by the blocking part.

Further, since the blocking part (upstream region 143A) and the support region (downstream region 143B) are integrally formed, the blocking part and the support region can be disposed in exhaust pipe 110 only with a process of disposing substrate 143, in the process of assembling exhaust purification apparatus 100. As a result, it is possible to simplify the process of assembling exhaust purification apparatus 100.

Further, in the embodiment described above, blocking part 150 and substrate 142 are configured to have an identical structure, but the present disclosure is not limited thereto. Blocking part 150 and substrate 142 may not have an identical structure.

In addition, any of the embodiment described above is only illustration of an exemplary embodiment for implementing the present disclosure, and the technical scope of the present disclosure shall not be construed limitedly thereby. That is, the present disclosure can be implemented in various forms without departing from the gist or the main features thereof.

This application is based upon Japanese Patent Application No. 2018-223383, filed on Nov. 29, 2018, the entire contents of which are incorporated herein by reference.

### INDUSTRIAL APPLICABILITY

The exhaust purification apparatus of the present disclosure is useful as an exhaust purification apparatus and a vehicle that are capable of restraining a catalyst of a selective reduction catalyst from being scraped off by a reducing agent solid, and further restraining a decrease in purification efficiency of an exhaust gas.

### REFERENCE SIGNS LIST

1 Internal combustion engine
100 Exhaust purification apparatus
110 Exhaust pipe
120 Reducing agent supply part
130 Mixing part
140 Selective reduction catalyst
141 Catalyst
142 Substrate
150 Blocking part
V Vehicle

1. An exhaust purification apparatus, comprising:
an exhaust pipe through which an exhaust gas generated in an internal combustion engine flows;
a selective reduction catalyst provided in the exhaust pipe and promoting reduction of nitrogen oxide in the exhaust gas;
a reducing agent supply part provided in a stage before the selective reduction catalyst in the exhaust pipe and supplying a reducing agent that reduces the nitrogen oxide in the exhaust gas; and
a blocking part provided between the reducing agent supply part and the selective reduction catalyst in the exhaust pipe, the blocking part blocking movement of a reducing agent solid towards the selective reduction catalyst when the reducing agent solid flows through the exhaust pipe together with the exhaust gas.

2. The exhaust purification apparatus according to claim 1, wherein
the blocking part is separated from the selective reduction catalyst.

3. The exhaust purification apparatus according to claim 2, wherein:
the selective reduction catalyst includes a substrate and a catalyst, the substrate having a structure in which a passage hole for the exhaust gas is formed, the catalyst being supported on the substrate, and
the blocking part has a structure identical to the structure of the substrate.

4. The exhaust purification apparatus according to claim 1, wherein:
the selective reduction catalyst includes a substrate,
the substrate including:
a support region on which a catalyst is supported; and
a non-support region which is located more on an upstream side in the exhaust gas than the support region and on which the catalyst is not supported, and
the blocking part is the non-supported region of the substrate.

5. The exhaust purification apparatus according to claim 1, wherein
the blocking part is formed of a material harder than the reducing agent solid.

6. The exhaust purification apparatus according to claim 5, wherein
the blocking part is formed of a metal.

7. A vehicle, comprising the exhaust purification apparatus according to claim 1.
